(19) United States
(12) Patent Application Publication
(10) Pub. No.: US 2003/0133554 A1
(43) Pub. Date: Jul. 17, 2003

(54) System and method for facilitating access to network based services

(75) Inventors: Petri Nykanen, Nokia (FI); Seppo Pohja, Tampere (FI); Heikki Koivu, Tampere (FI)

Correspondence Address: ALTERA LAW GROUP, LLC, 6500 CITY WEST PARKWAY, SUITE 100, MINNEAPOLIS, MN, 55344-7704, US

(73) Assignee: Nokia Corporation, Espoo (FI)

(21) Appl. No.: 10/043,935

(22) Filed: Jan. 11, 2002

(51) Int. Cl. H04M 3/42

(52) U.S. Cl. 379/201.01

(57) ABSTRACT

A system and method for facilitating web service component access. A One Logical View to Broker (OLVB) Application Program Interface (API) is established for application (402) in order to reduce the complexity of the application interface and subsequently increase the portability of application (402). Network Service Broker related parameters (204,304) allows the solicitation of the best match Network Service Broker or web service component, while hiding the selection detail from application (402). Real-time business relationships between Service Provisioning Infrastructure (208) and Network Service Brokers (212, 232, 238) is facilitated by using matchmaking function (416) within lookup function (414).

### FIELD OF THE INVENTION

The present invention relates generally to network communications systems, and more particularly, to a system and method for facilitating access to network services offered by the network communications systems.

### BACKGROUND OF THE INVENTION

Today's communications technologies have brought about a dramatic expansion and diversification in networking infrastructure. Network access has progressed from simple point to point connection threads between two network nodes, to complex, multi-point connection webs involving many hundreds of thousands of nodes consisting of mobile telephones, fixed workstations, laptop computers, Personal Data Assistants (PDA), applications servers etc., distributed amongst both wireline and wireless networks, where each network node obeys communication rules or protocols necessary to traverse the network from node to node.

The diversification of the communications networks and their associated communication protocols have created a plethora of standardized models for communication. Many of the standardized models have adopted the Open Systems Interconnection (OSI) reference to be used as a baseline model, which lends itself well to point-to-point data communications. The OSI model provides the basis for connecting open systems for distributed applications processing, thus providing a common groundwork for the development of families of standards permitting data assets to communicate. The OSI model establishes seven communication layers arranged vertically, or stacked, starting from the bottom layer, which provides the physical Input/Output (I/O) ports established between two communicating entities. The other six layers, or peers, being virtually connected to each other according the established protocol for the particular layer.

The World Wide Web (WWW), or Internet, is not necessarily accessed by the point-to-point communications model as defined by the OSI reference model, for example, but instead utilizes ubiquitous Internet Protocol (IP) and data formats such as Hypertext Transfer Protocol (HTTP) and Extensible Markup Language (XML) to support its interfaces. As point to point communications within the Internet are giving way to a more distributed access, so are the standalone computing applications giving way to a more integrated approach, where applications, devices, and services work together within the Internet to achieve a common goal. Furthermore, the communications model is progressing towards a service oriented representation, or web service model, as a larger percentage of business processes now involve trading partners with whom interaction is increasingly automated. The web service model helps to facilitate the integration of applications whose operation requires firewall traversal, operation with varying operating system environments, and operation with varying middleware technology.

The web service model for interaction between two programs is based on XML standards using transports, such as HTTP, for example. Each program publishes its interfaces and other capabilities using an XML standard that clients recognize. The clients interact with the programs using XML-based protocol that promotes loose coupling and is ideal for programs that involve multiple parties. One consequence of loose coupling, however, is that any client requiring service from an unpublished web service, or web component, may be required to automatically discover the web service as required.

As web service applications become increasingly popular, many execution environments are being developed to accommodate the web component applications, such as Java environments, Microsoft.Net and Linux to name only a few. The Java 2 Enterprise Edition (J2EE), for example, is enjoying huge popularity in the vendor marketplace and within a large developer community. J2EE, for example, simplifies enterprise applications by basing them on standardized, modular components that are capable of executing on many different types of execution platforms.

Web services defines a model whose characteristics are ideal for connecting business functions across both fixed and mobile networks between and within enterprises. Network Service Brokers (NSB) may be generated to offer network service functionality to other network components that may be executing on terminals distributed within the fixed or mobile networks. The services exposed by the NSB, however, are often dependent upon the particular mobile or fixed network that the terminal is utilizing. In the case of a mobile terminal, for example, roaming allows the mobile terminal to be exposed to a multitude of networks as the mobile terminal traverses each network. Each network may have its own NSB, which allows access to the network services offered by the NSB. The NSB and the networks that they are attached to, however, often have different business relationships, which complicate the roaming agreements.

Another problem with the present methodology of requesting services from web services in general, is the complexity that is inherent with the discovery of services offered by the web services. Interfaces presented to the requesting application often are complex and customized, which requires a specific knowledge of the web service before a complete discovery of the offered service can be performed by the requesting application. Once discovered, the method of utilization of a particular web service presents still further levels of complexity. As can be seen, requesting applications that are performing web service discovery and web service utilization are required to be customized to the web service before meaningful data exchange can take place.

As network access to network services becomes increasingly distributed, the prior art network access paradigm becomes obsolete, necessitating the need for a simplified paradigm for the future. A simplified logical view to network services or their brokers, for example, is needed so that service requests from applications having no specific knowledge of the network services may be facilitated. The simplified logical view to the network services should be generalized so that execution may be facilitated within any execution environment. Furthermore, the network service should be allowed to exist within any network element as required, such as mobile terminals, applications servers, personal computers, etc.

Accordingly, there is a need in the network communications industry to equip web service clients with enabling technology so that developer-friendly web services, or web components, can be utilized. The web service clients require Application Program Interfaces (APIs) having one logical view, which reduces the complexity of the web service client and increases its portability. The present invention solves these and other shortcomings of the prior art, and offers numerous advantages over prior art network service access.

### SUMMARY OF THE INVENTION

The present invention is directed to a system and method for facilitating access to network services. The present invention involves providing a protocol based or a software based interface module definition, which hides the complexity associated with discovery and service utilization details inherent with web service selection across the network. The present invention enables the interface module to maintain information on the business relationships between the associated networks and to employ a decision function with multiple parameters to automatically select the best match NSB or web service component as requested by the application. The present invention further enables the interface module to automatically enter into a matchmaking process with networks, while eliminating the direct interaction between the owners of the networks and the SPI.

In accordance with one embodiment of the invention, a method is provided to establish network services within a network having a plurality of service components. The method provides a plurality of interface modules to establish communications with one of the plurality of service components. The method further provides one logical access point to the plurality of interface modules to facilitate invocation of one of the plurality of service components. The method receives service component related parameters and selects one of the plurality of service components in response to the invocation. The service component related parameters provide dynamic selection optimization of the one of the plurality of service components. The interface modules being either software or protocol based modules.

In accordance with another embodiment of the invention, a system for facilitating network services in response to a service request and associated service request parameters is provided. The system includes a plurality of service components distributed within a network and an interface module having a plurality of interface objects to establish communications with one of the plurality of service components. The interface module includes a lookup object in communication with the plurality of interface objects to establish connection parameters required between the one of the plurality of service components and one of the plurality of interface objects, a data object in communication with the lookup object to provide parameters identifying attributes associated with the plurality of service components, and a single logical access point to allow external access to the plurality of interface objects. The interface objects may either be software based or protocol based objects.

In accordance with another embodiment of the invention, a computer-readable medium having computer-executable instructions for establishing network services within a network having a plurality of service components is provided. The computer-executable instructions performing the steps of providing a plurality of interface modules to establish communications with one of the plurality of service components. The one logical access point to the plurality of interface modules allows external invocation of one of the plurality of service components. The steps further including receiving service component related parameters, and selecting one of the plurality of service components in response to the invocation. The service component related parameters provides dynamic selection optimization of the one of the plurality of service components.

The above summary of the present invention is not intended to describe each illustrated embodiment or implementation of the present invention. This is the purpose of the figures and the associated discussion which follows.

### BRIEF DESCRIPTION OF THE DRAWINGS

The invention is described in connection with the embodiments illustrated in the following diagrams.

FIG. 1 illustrates a communications network;

FIG. 2 illustrates an application seeking a service broker from a set of networked service brokers;

FIG. 3 illustrates an application seeking a web service component from a set of networked web service components;

FIG. 4 illustrates a software interface approach to the One Logical View to Broker paradigm;

FIG. 5 illustrates a protocol interface approach to the One Logical View to Broker paradigm; and

FIG. 6 illustrates a flow diagram useful in explaining the operation of a simplified access to web services.

### DETAILED DESCRIPTION OF THE VARIOUS EMBODIMENTS

In the following description of the various embodiments, reference is made to the accompanying drawings which form a part hereof, and in which is shown by way of illustration various embodiments in which the invention may be practiced. It is to be understood that other embodiments may be utilized, and structural and functional modifications may be made without departing from the scope of the present invention.

The present invention is directed to a system and method for facilitating access to network services. The present invention involves providing a protocol based or a software based interface module definition, which hides the complexity associated with discovery and service utilization details inherent with web service selection across the network. The present invention enables the interface module to maintain information on the business relationships between the associated networks and to employ a decision function with multiple parameters to automatically select the best match NSB or web service component as requested by the application. The present invention further enables the interface module to automatically enter into a matchmaking process with networks, while eliminating the direct interaction between the owners of the networks and the SPI.

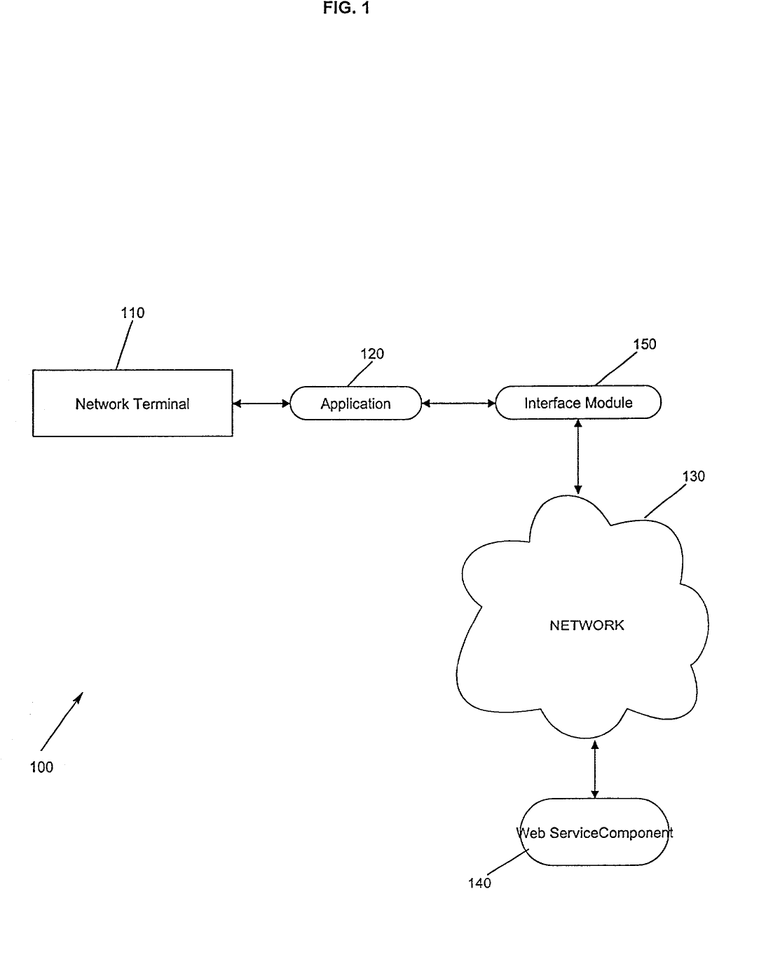

FIG. 1 is an exemplary embodiment of a network system 100 which employs developer friendly web service, or web component, access in accordance with the principles of the present invention. Terminal 110 may comprise any mobile network element such as a mobile Terminal Equipment (TE), PDA or laptop computer, for example. Terminal 110 may also comprise any fixed network element such as a personal desk top computer or application server, for example. Network 130 may comprise the Internet, mobile communications networks, public or private land line communications networks or any combination thereof. Web service component 140 comprises, for example, any network component provided as a web service to network 130. In general, web service component 140 is either a web service, an NSB, or any component that contains an interface consistent with a web service, which is accessible by application 120. Web service component 140 is considered to be a service endpoint for application 120, for example, and may further correspond to mobile terminals, servers, network elements, etc. Protocol access to web service component 140 may be implemented using any number of web service protocols, such as HTTP, Simple Object Access Protocol (SOAP), or Business Transaction Protocol (BTP), etc., but may also be accessed using other, non-web service stack protocols, such as Transmission Control Protocol/Internet Protocol (TCP/IP) or User Datagram Protocol (UDP), for example. Application 120 represents any node equipped to request any network enabled service, but through the interaction of interface module 150, is able to connect to the correct endpoint, or web service component, as needed. Interface module 150 may be exemplified as a Java application running on a multitude of execution environments, however, may also represent applications running in any execution environment, such as Microsoft.NET or Linux environments, for example. Furthermore, the protocol interface between network 130 and interface module 150 may be based on any number of protocol stacks including HTTP, SOAP, BTP, etc. Application 120 maintains no visibility to web service component 140, in accordance with the present invention, since interface module 150 provides all business related functionality effective to hide the complexity of selecting web service component 140 from application 120. The simplified logical view provided by interface module 150 may be implemented by a software based or a protocol based interface, where details regarding the selection of the best web service component, or endpoint, is hidden from application 120. Furthermore, interface module 150 provides dynamic decision functions, so that business relationships within network 130 may be established automatically as required.

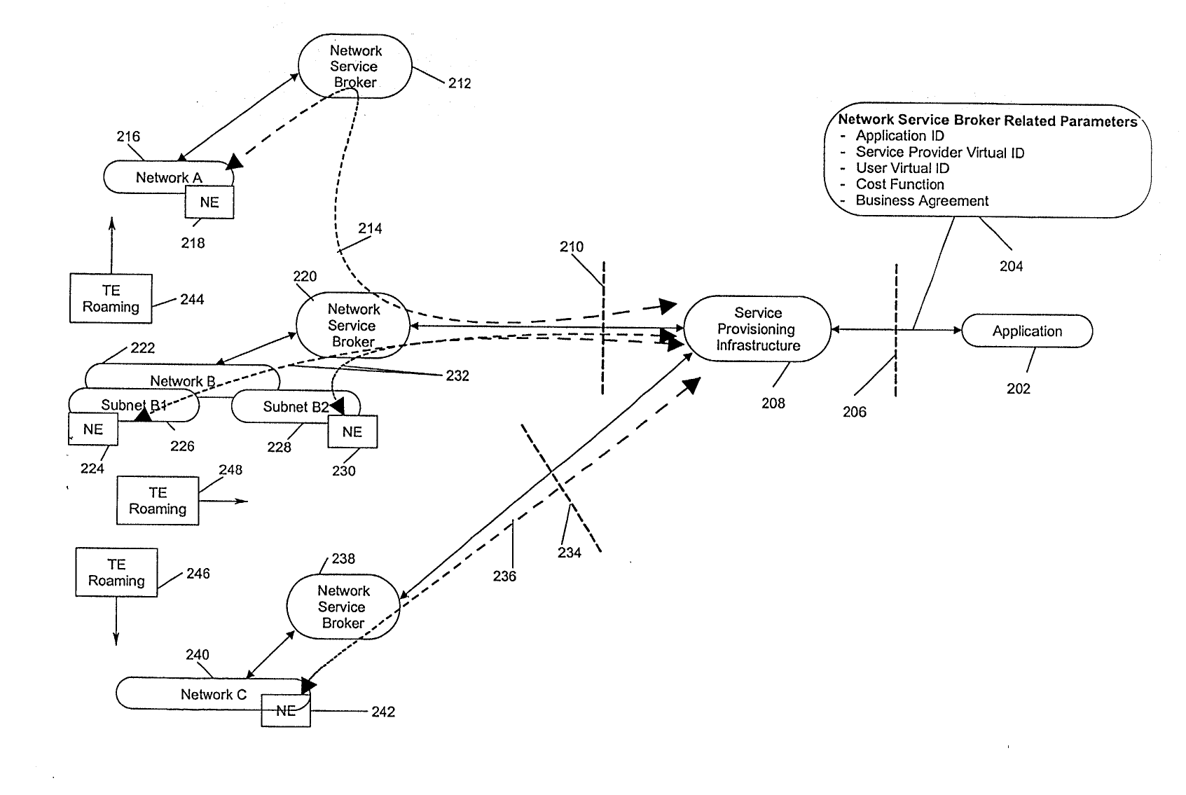

FIG. 2 illustrates a situation wherein application 202 requests service from SPI 208, where multiple NSBs 212, 220 and 238 may be selected to provide the requested service. Application 202 communicates to SPI 208 via either a protocol interface or a software interface illustrated by interface 206 as discussed in detail below. Network service broker 220 represents, for example, a location broker in Network B 222, which is the home network of Terminal Equipment 244, 248 and 246. NSB 220 handles location service requests presented by application 202 to SPI 208 via interface 206. Protocol interface 210 may consist of any number of protocols to include HTTP, SOAP or BTP, for example.

Network B 222 comprises subnetwork B1 226 and subnetwork B2 228, which may represent network infrastructure owned by a single operator of Network B 222, but whose subnetwork infrastructure has two separate manufacturers for subnetworks B1 226 and B2 228. Infrastructure associated with subnetwork B1 226, therefore, has complexities that are different than the infrastructure complexities associated with subnetwork B 228. The difference of complexities, however, is hidden from SPI 208 by location broker NSB 220, such that SPI 208 requires no knowledge of the difference in complexities between subnetwork B1 226 and subnetwork B2 228 during location service requests. In general, SPI 208 requires no specific knowledge of the complexities of Networks A 216, B 222 or C 240, since NSB 220 makes the complexities transparent to SPI 208.

Several roaming scenarios exist in association with TE 244, 246 and 248, in which NSB 220, acting as a location broker for example, handles location requests from application 202, with regard to TE 244, 246 and 248. One such roaming scenario involves TE 244, being homed in Network B 222, roams into Network A 216. Location request 214 from application 202 is processed by SPI 208 and forwarded onto NSB 220. As TE 244 roams into Network A 216, location updates are no longer required of Network B 222, but rather are now required of Network A 216. Network A 216 and Network B 222, however, each may have differing complexities, which are known by location broker NSB 220. By having a service roaming agreement in place between operators of Network A 216 and operators of Network B 222, the location broker NSB 220 is allowed to conduct location updates, in conjunction with location broker NSB 212, between Network Element (NE) 218 of visited Network A 216 and the correct NE of Network B 222, as required to determine the position of TE 244. SPI 208, by virtue of roaming agreements between location broker NSB 220 and location broker NSB 212, is not required to have any knowledge of the complexity difference between Network A 216 and Network B 222 because location broker NSB 220 hides the complexity difference between Network A 216 and Network B 222.

A similar roaming effect exists, wherein the correct NE of Network B 222, having knowledge of the roaming condition of TE 244, contacts NE 218 of Network A 216 to receive the location update of roaming TE 244. In this case, roaming is not handled within the NSB 220 to NSB 212 connection, but rather is handled at the NE level, where NE 224 of Network B 222, for example, directly contacts NE 218 of Network A 216 to conduct position updates. The complexity difference between Networks A and B remain hidden from SPI 208 due to the roaming agreements established between the operators of Network A 216 and Network B 222.

An additional roaming scenario exists, such that TE 248, being homed in subnetwork B1 226, roams into subnetwork B2 228. Location request 232 from application 202 is processed by SPI 208 and forwarded to NSB 220. As TE 248 roams into subnetwork B2 228, location updates are no longer required of subnetwork B1 226, but rather are now required of subnetwork B2 228. Subnetwork B1 226 and subnetwork B2 228 each may have differing complexities, which are known by location broker NSB 220. Location broker NSB 220 services location update requests from SPI 208, while TE 248 roams between subnetwork B1 226 and subnetwork B2 228 as required to determine the position of TE 248. SPI 208, by virtue of location broker NSB 220, is not required to have any knowledge of the complexity difference between subnetwork B1 226 and subnetwork B2 228 because location broker NSB 220 hides the complexity difference between subnetwork B1 226 and subnetwork B2 228.

A further roaming scenario exists, such that TE 246 roams into Network C 240 from Network B 222. As can be seen, location request 236 is not processed by NSB 220, but rather is directly sent to NSB 238. One reason for the non-utilization of location broker NSB 220 includes the possibility that the operators of Network B 222 and the operators of Network C 240 do not have a roaming agreement in place. Such may be the case if, for example, Network C 240 is represented by a wireless Local Area Network (LAN) or corporate LAN. Roaming agreements are not likely to be in place when TE 246 roams into Network C 240 and NSB 220, subsequently, is not allowed to process location update requests from SPI 208. Since both NSB 220 and 238 are visible by SPI 208, and further since no roaming agreement exists between the operators of Network B 222 and Network C 240, SPI 208 is exposed to the problem of determining which of NSBs 220 or 238 to use for location updates of TE 246.

When SPI 208 is exposed to the location broker selection problem, application 202, executing within SPI 208 or external to SPI 208, is likewise exposed to the selection problem. Once application 202 is exposed to the selection problem, application 202 becomes tightly coupled to SPI 208 and thus becomes less portable to other SPI applications. Specialized code bases required to handle the location broker selection problem are then required to increase capacity and application 202 is eventually required be tailored to SPI 208.

An important aspect of the present invention is, therefore, to prevent the necessity to tailor applications to their respective host SPI, by creating a paradigm of One Logical View to Broker (OLVB) Application Program Interface (API) to the application. In other words, a particular application may communicate with any particular NSB, without exposure to any specific complexities found in the web service or web component offered by the NSB.

NSB parameter list 204 may be necessary in order to facilitate the OLVB paradigm. Each application may need to provide its own unique identification number, for example, so that the particular NSB in communication with the application may track the service level that is available to the application. If the identification number used by an application requesting location data of a TE indicates, for example, that the granularity to be used for location reports is at the metropolitan area level, then the location broker in communication with the application only delivers location updates at that granularity, even though other granularities may exist. Such as is the case, for example, when exact coordinates of the TE are obtainable through the use of the Global Positioning System (GPS). In addition, the unique identification number of the application may be required to enforce security requirements that the end user or other policy setting parties may have established for providing, for example, location update information to requesting applications.

A unique service provider identification number may also be required in the case where the particular SPI is used as a platform to host application 202. The identity of the owner of the SPI may be replaced with the identity of the actual SPI in order to gain access to the services offered by the NSBs, in accordance, for example, with strong authentication methods. The SPI, for example, may have a different business agreement with the NSB than does the party which is hosting the application on the SPI. For example, when a cellular operator is hosting an application in its SPI for a corporate customer, the corporate customer's wireless LAN network does not accept queries, in general, from the operator's SPI. If, however, the service provider's identification number is provided to the NSB of the corporation, then the communication between the SPI and the NSB is accepted.

A unique user identification number may be necessary when services of the NSB are related to a specific TE or user identity. For example, choosing the right location broker may depend on the specific identity of the TE, since even the location broker of the home network of the TE may need the user identification number to determine where the location information is to be found. A cost function may also be required when service is available from multiple NSBs. The application, through the use of the cost function, is able to define and limit the costs associated with services provided by the NSB. A business agreement may also be necessary, so that the application is able to determine, or to indicate or enforce, which business agreement to utilize. During the selection process, for example, the SPI may select a service broker that is a member of the business agreement as specified by the business agreement in NSB related parameter list 204. It is to be understood that NSB related parameter list 204 may not represent an exhaustive parameter list that may be required to provide the OLVB paradigm in accordance with the present invention, but is rather presented to represent an exemplary list of parameters that may be useful to provide the OLVB paradigm.

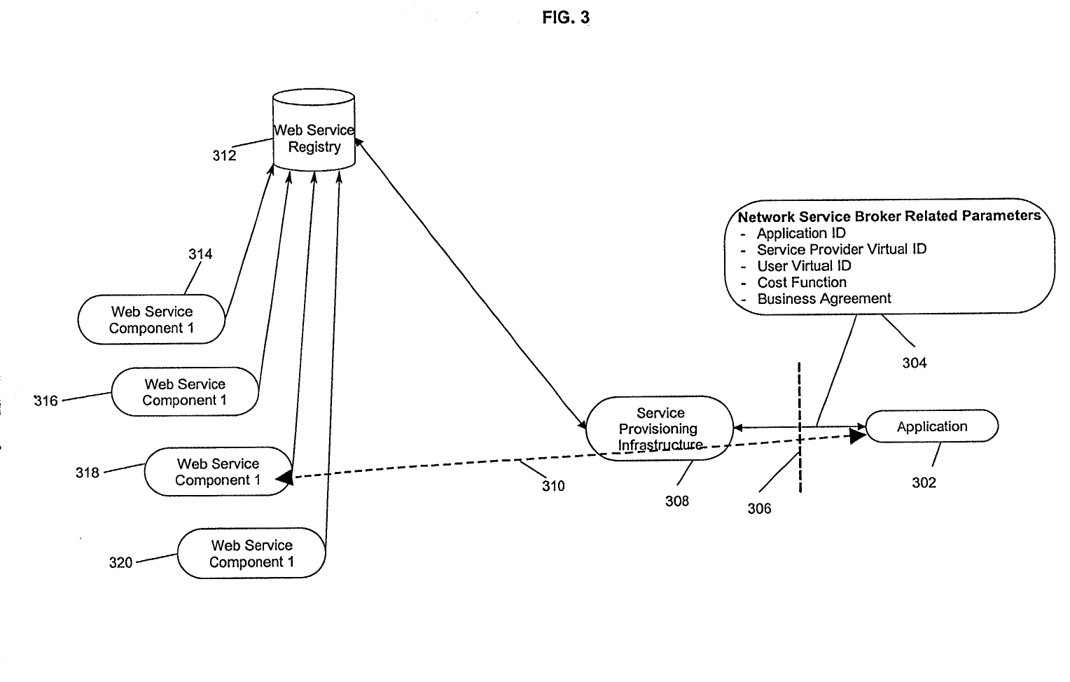

FIG. 3 illustrates the general problem wherein application 302 is presented with multiple web service components from which to choose the best web service component based on NSB related parameter list 304. Application 302 communicates to SPI 308 via either a protocol interface or a software interface illustrated by interface 306 as discussed in detail below. In general, multiple web service components 314-320 are available for use by SPI 308. Each web service component 314-320 has service characteristics that are reported to web service registry 312. In general, web service components 314-320 are not required to be web services as discussed above, but rather need only be network components having an interface consistent with web services.

Registry 312 may be implemented as specified by the Universal Discovery Description Integration (UDDI) specification for distributed, web-based information registries for web services. The registries are publicly accessible and support, for example, service type registration for software companies, individual developers, standards bodies, and business registration types for describing company supported services. UDDI includes the shared operation of a business registry on the web. The UDDI business registry is used at a business level to check whether a given partner has a particular web services interface. In addition, the UDDI business registry is used to find companies in a given industry with a given type of service and locate information about how a partner or intended partner has exposed a web service. From the information provided in registry 312, details specific to the operation of web service components 314-320 are obtained. From a J2EE perspective, UDDI registry 312 is simply a repository containing specific and associated web services information, for example, like Java Naming and Directory Interface (JNDI), and may or may not host the web service component itself. NSB related parameter list 304 enables SPI 308 to select web service components, for example, that SPI 308 or the owner of the hosted application 302 may have a business agreement with. Furthermore, NSB related parameter list 304 facilitates matchmaking between web service components 314-320 and SPI 308 that do not have a current business agreement in place. Still further, parameter list 304 enables the most cost effective match between application 302 and web service components 314-320 using the cost function.

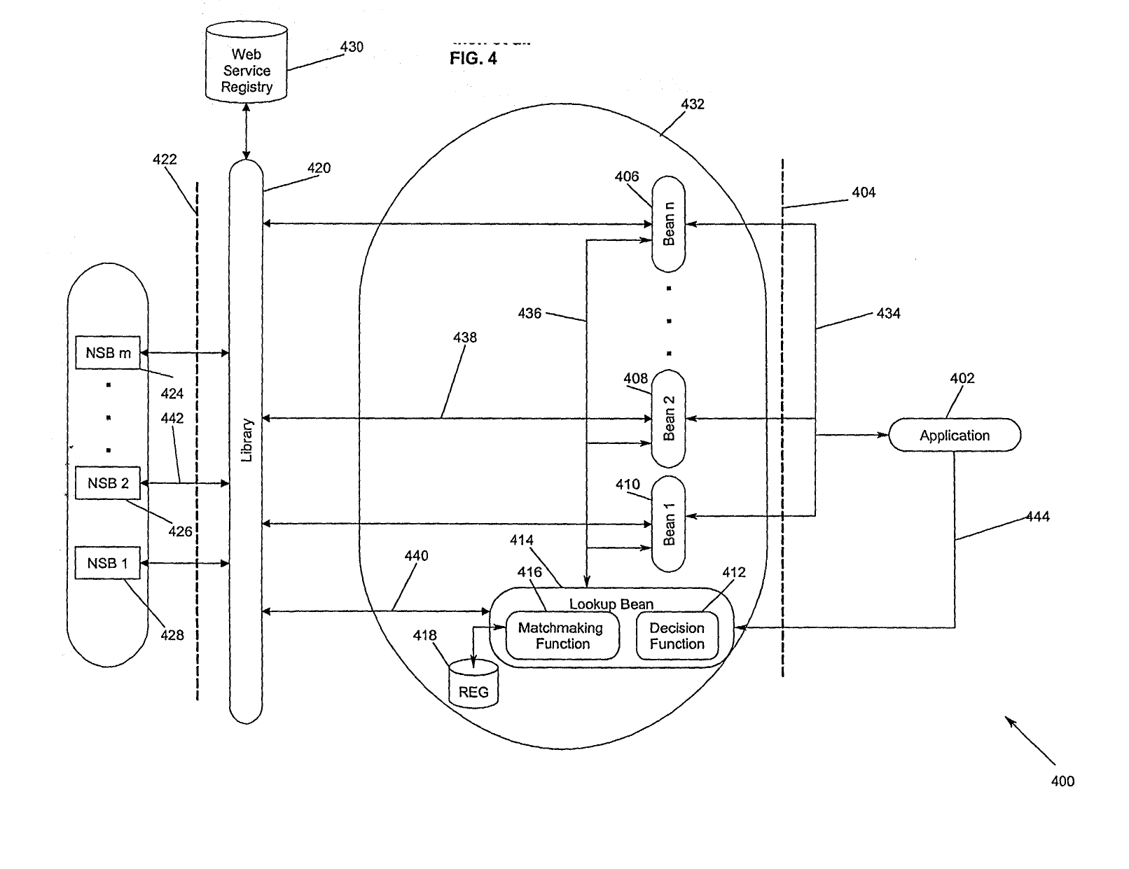

FIG. 4 illustrates an exemplary J2EE web service environment according to the present invention, illustrating a software interface based approach between application 402 and NSBs 424-428. NSBs 424-428 are equivalent to the NSBs shown in FIG. 2 and FIG. 3 or may represent actual web services or web components having a web service interface. Application 402, software interface module 432, and library 420 may all co-exist on a Java application server environment. In general, beans 406-410 and 414 represent software modules, libraries, agents or objects whose methods, services, data, and functionality are enabled through software interface 404 by application 402. Although a J2EE implementation is illustrated, it should be noted that any number of implementations are viable, such as for example, Microsoft.NET and Linux applications.

Beans 406-410, represent a plurality of enterprise beans, for example, which execute within an Enterprise Java Bean (EJB) container within the Java environment. Each enterprise bean may represent the business logic of an application and may take on various functional types such as session or entity and may perform a specific task for a requesting client. For example, bean 410 may correspond to a location request task, which may contact one of NSBs 424-428 to perform a location verification of a TE, as discussed above in regard to FIG. 2, for example. In general, enterprise beans 406-410 constitute broker service specific software libraries or objects that hide broker or web service complexity from application 402, which supports the OLVB paradigm, thereby reducing the complexity of interface 404 and increasing the portability of application 402. Although enterprise beans 406-410 may be established with a one-to-one correspondence between brokers 424-428, certainly other relationships may exist between beans 406-410 and brokers 424-428, such as the interaction of multiple beans to implement an interface to brokers 424-428.

Bean 414 exists as a separate functional block for common functions of enterprise beans 406-410. In the J2EE implementation, for example, bean 414 is referred to as a lookup bean. Lookup bean 414 contains decision function 412 that receives as input, parameters as listed in NSB related parameter list 204 and 304 of FIGS. 2 and 3, for example. The parameters, or a subset of them, may be provided through any of beans 410, 408, 406. In such cases, application 402 does not have direct communication 444 with lookup bean 414. Another case is possible where application 402 actively requests for the lookup functionality through 444 before communicating with beans 406-410. Such communication may enable the application to have some enhanced control over which NSB will be selected. However, as this may limit the portability of application 402, the access to lookup function 414 directly from application 402 is not recommended in normal implementations. The output of decision function 412 provides the connection parameters required to communicate with matching service brokers 424-428. In general, components 424-428 may represent web services or web components having a web service interface.

Matchmaking function 416 of lookup bean 414 may also be realized to provide a dynamic business relationship between the SPI and the matching service broker. For example, while the lookup function performed by lookup bean 414 may consult a lookup table stored in local or remote database REG 418 to establish a connection to a matching NSB, such as the required address of the NSB, the lookup function is not necessarily able to circumvent the absence of a business relationship between the SPI and the matching NSB. The role of matchmaking function 416 is to extend the semi-static lookup functionality of lookup bean 414 to initiate a real-time business relationship that is established between the owner of the SPI, or the hosted application, and the owner of the NSB. An external connection 444 to lookup bean 414 is also provided to application 402 if needed, however, other implementations may exist, which either prohibit, limit or mandate external connection 444 as discussed above. Data base 418 represents a data registry, much like web service registry 430, where attributes of the web services offered by NSB 424-428 may be stored and later accessed by matchmaking function 416 and decision function 412 during web service discovery.

Library 420 represents, for example, all APIs that enable utilization of web service related protocols such as Java API for XML Processing (JAXP), which supports the processing of XML documents, Java API for XML Messaging (JAXM), which enables applications to send and receive document oriented XML messages, Java API for XML based Remote Procedure Calls (JAXP-RPC) for building RPC functionality using the SOAP specification and Java API for XML Registries (JAXR) for XML access to web service registries.

The web service environment as depicted in FIG. 4 provides an exemplary environment according to the present invention, which yields the OLVB paradigm with regard to application 402. Interfaces 434 and 440 provide a simplified and portable API to application 402, which may remain constant regardless of the hosting application server for application 402. EJBs 406-410 may be instantiated by application 402 via interface 434 through the use of specific client messages transmitted to EJBs 406-410, such as may be used with message-driven beans, through the use of the Java Message Service (JMS). Once the message-driven bean has been instantiated by application 402, interface 436 provides lookup bean 414 with the required information needed such that lookup bean 414 is cognizant of the service type requested by application 402. Application 402 may either transfer NSB related parameters 204 directly to lookup bean 414 via interface 444, or may transfer the NSB related information via interface 434.

Once lookup bean 414 is in possession of the particular service type requested by application 402 and any NSB related parameters that may have been supplied by application 402, lookup bean 414 utilizes interface 440 to search web service registry 430, via JAXR during discovery, to find the best match NSB according to the service requested by application 402 and the optionally associated NSB related parameters. The best match selection process is a dynamic optimization selection process, which utilizes the NSB related parameters and the service request of application 402 to select the best service component having the most compatible features for application 402. Registry 418 may then be updated with the results of the dynamic optimization selection process for future access. The best match NSB and the corresponding message-driven bean are then virtually connected via interfaces 442 and 438 through the appropriate Java APIs existing within library 420. Application 402 then communicates with the instantiated EJB, via interface 434, to receive data in response to the service request, thus ending the transaction.

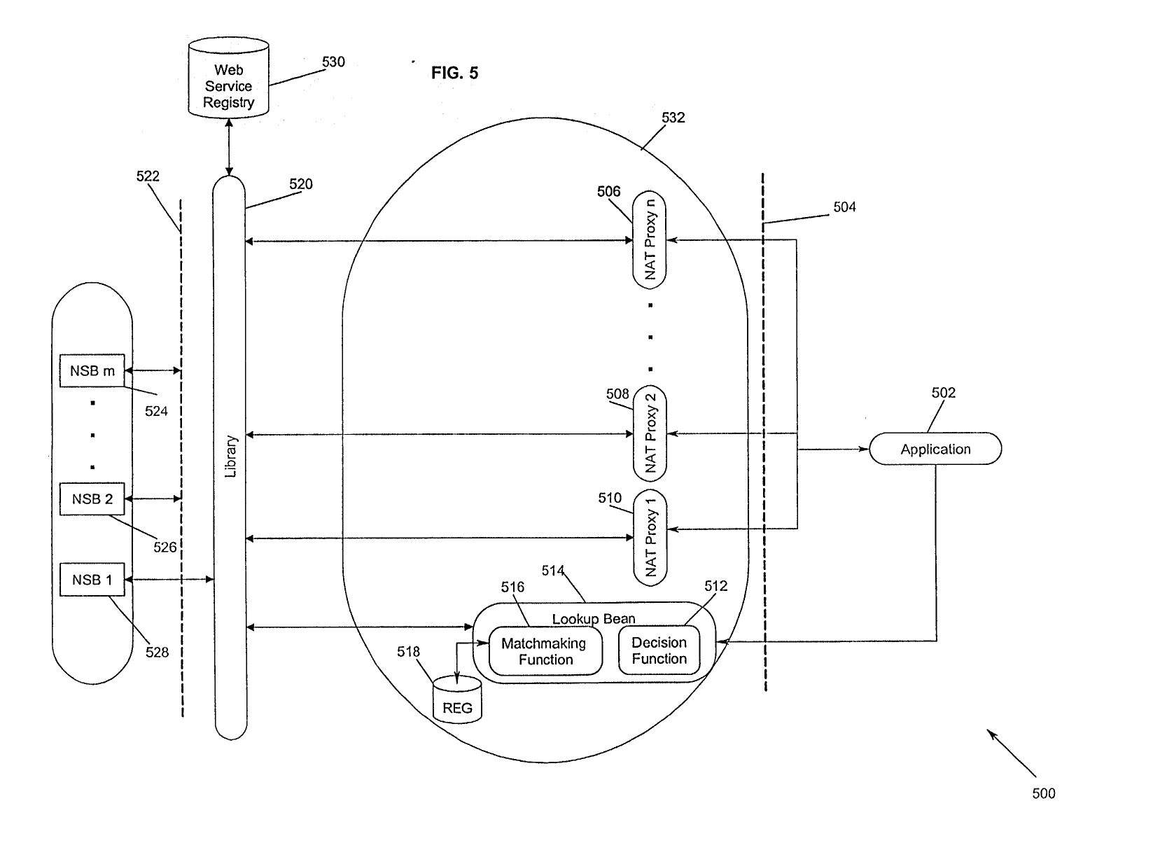

FIG. 5 illustrates an exemplary J2EE web service environment according to the present invention, illustrating a protocol interface based approach between application 502 and NSBs 524-528. NSBs 524-528 are equivalent to the NSBs shown in FIG. 2 and FIG. 3 or may represent actual web services or web components having a web service interface. Application 502, protocol module 532, and Library 520 may all co-exist on a Java application server environment. Although a J2EE implementation is illustrated, it should be noted that any number of implementations are viable, such as for example, Microsoft.NET and Linux applications.

FIG. 5 represents an alternate embodiment according to the present invention to implement the OLVB paradigm using protocol interface module 532 as one possible alternate to the software interface module illustrated in FIG. 4. Communication between application 502 and NSBs 524-528 is performed end to end utilizing the web service protocols in Library 520, where no mapping of application interface to web service protocols takes place. Network Address Translation (NAT) proxies 506-510 hide the IP addresses of NSBs 524-528 from application 502, so that application 502 does not necessarily contain the static IP addresses of NSBs 524-528. Selection of the correct service broker is performed by the functionality of both the NAT proxies 506-510 and lookup function 514.

It should be noted that matchmaking function 416 and 516 as illustrated in FIGS. 4 and 5 seeks to utilize as many pre-existing key technologies available on the Internet as possible, rather than to duplicate them. One example of core technology reuse concerns the key technology of Hewlett Packard's (HP) e-Speak. HP's e-Speak allows consumers, that have access to the Internet, the capability to find and connect to service providers based on a query from the consumer. The e-Speak engine, however, may not have the capability, for example, to search out and find the “best” supplier for the particular service sought by the consumer, but rather must be given a definition of the term “best” .

One possible example of the interaction between the matchmaking function according to the present invention and the linkage to an existing key technology such as e-Speak, is to represent HP's e-Speak as its own web service, web component or service broker. Lookup function 414 or 514 may then be employed to filter the output provided by HP's e-Speak to find the “best” service supplier in view of NSB related parameters 204 or 304. One such example of filtering the output of HP's e-Speak may involve a service request for an English translation of a document written in the French language, which costs less than $25. HP's e-Speak may then be tasked with finding all French translation services on the network, while the cost function parameter in conjunction with lookup function 414 or 514 limits all e-Speak reported translation services providers to only those whose cost for translation does not exceed $25.

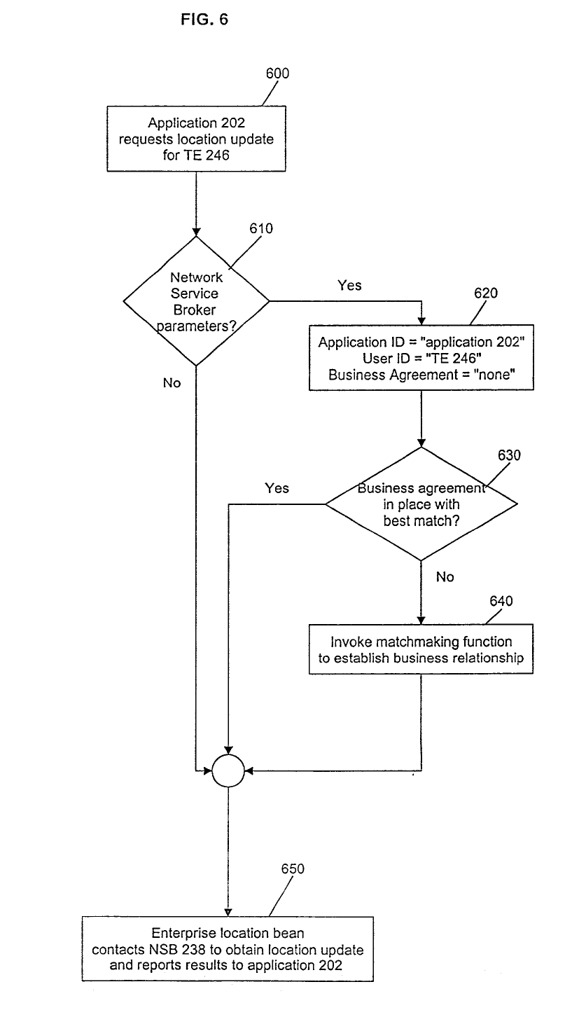

FIG. 6 illustrates a flow diagram in accordance with the present invention, which is useful in explaining the operational aspects of FIG. 2 during the roaming of TE 246 from Network B 222 to Network C 240 in combination with the diagram of FIG. 4. In step 600, application 202 requests a location update for TE 246 after TE 246 has roamed into Network C 240. The application ID, User ID and Business Agreement data is supplied by application 202 for the location update. Step 610 verifies that NSB related parameters exist. Step 620 indicates that the application ID is to receive a location update with best possible resolution, since “application 202” is privileged to such accuracy. User ID indicates that the location request is required of “TE 246” and the Business Agreement parameter indicates that no business agreement is in place between Network B 222 and Network C 240. Decision function 412 receives the NSB related parameters and determines, in step 630, that although NSB 238 is the correct match based on the parameter list, but no business agreement is in place between NSB 220 and NSB 238. Matchmaking function 416 is invoked, in step 640, to automatically create a business relationship between NSB 220 and NSB 238. Step 650 invokes the location update service provided by NSB 238 and the service request completes.

In summary, a developer-friendly API is realized having a One Logical View to Broker paradigm, which simplifies the interface between the service requesting application and the service broker or web service component. In addition, the application is rendered to have greater portability, since knowledge of the web service complexities does not exist within the application. A semi-static lookup of an NSB having a business relationship with the requesting application is enabled. In those cases where an NSB does not have a business relationship established with the requesting application, however, a dynamic operation is established during the service request, which provides for dynamic negotiation of business relationships between the service providing entities and the requesting application.

Using the foregoing specification, the invention may be implemented as a network system, networked apparatus, process, or article of manufacture by using standard programming and/or engineering techniques to produce programming software, firmware, hardware or any combination thereof.

Any resulting program(s), having computer-readable program code, may be embodied within one or more computer-usable media such as memory devices or transmitting devices, thereby making a computer program product or article of manufacture according to the invention. As such, the terms “article of manufacture” and “computer program product” as used herein are intended to encompass a computer program existent (permanently, temporarily, or transitorily) on any computer-usable medium such as on any memory device or in any transmitting device.

Executing program code directly from one medium, storing program code onto a medium, copying the code from one medium to another medium, transmitting the code using a transmitting device, or other equivalent acts, may involve the use of a memory or transmitting device which only embodies program code transitorily as a preliminary or final step in making, using, or selling the invention.

Memory devices include, but are not limited to, hard disk drives, diskettes, optical disks, magnetic tape, semiconductor memories such as RAM, ROM, PROMS, etc. Transmitting devices include, but are not limited to, the Internet, intranets, telephone/modem-based network communication, hardwired/cabled communication network, cellular communication, radio wave communication, satellite communication, and other stationary or mobile network systems/communication links.

A machine embodying the invention may involve one or more processing systems including, but not limited to, CPU, memory/storage devices, communication links, communication/transmitting devices, servers, I/O devices, or any subcomponents or individual parts of one or more processing systems, including software, firmware, hardware, or any combination or subcombination thereof, which embody the invention as set forth in the claims.

From the description provided herein, those skilled in the art are readily able to combine software created as described with appropriate general purpose or special purpose computer hardware to create a computer system and/or computer subcomponents embodying the invention, and to create a computer system and/or computer subcomponents for carrying out the method of the invention.

It will, of course, be understood that various modifications and additions can be made to the various embodiments discussed hereinabove without departing from the scope or spirit of the present invention. For example, the invention may be used in connection with any type of execution environment, and is not limited to the exemplary J2EE execution environments described above. From the foregoing description of the illustrated embodiments, those of ordinary skill in the art will readily appreciate the applicability of the invention in any comparable execution environment, such as Microsoft.NET and Linux for example. Accordingly, the scope of the present invention should not be limited by the particular embodiments discussed above, but should be defined only by the claims set forth below and equivalents thereof.

It will, of course, be understood that various modifications and additions can be made to the various embodiments discussed hereinabove without departing from the scope or spirit of the present invention. Accordingly, the scope of the present invention should not be limited by the particular embodiments discussed above, but should be defined only by the claims set forth below and equivalents thereof.

What is claimed is:

1. A method for establishing network services within a network having a plurality of service components, comprising:
providing a plurality of interface modules to establish communications with one of the plurality of service components;
providing one logical access point to the plurality of interface modules to facilitate invocation of one of the plurality of service components;
receiving service component related parameters; and
selecting one of the plurality of service components in response to the invocation, wherein the service component related parameters provides dynamic selection optimization of the one of the plurality of service components.

2. The method of claim 1, wherein providing a plurality of interface modules comprises providing a plurality of software objects accessible by messages received from the one logical access point.

3. The method of claim 2, wherein receiving service component related parameters comprises receiving the service component related parameters via the one logical access point.

4. The method of claim 3, wherein receiving service component related parameters comprises receiving the service component related parameters via an external connection.

5. The method of claim 4, wherein selecting one of the plurality of service components comprises using the service component related parameters to reduce an initial number of potentially compatible service components.

6. The method of claim 5, wherein selecting one of the plurality of service components further comprises using the service component related parameters to initiate a business agreement with the one of the plurality of service components.

7. The method of claim 1, wherein providing a plurality of interface modules comprises providing a plurality of network address translation proxies accessible by messages received from the one logical access point.

8. The method of claim 7, wherein receiving service component related parameters comprises receiving the service component related parameters via the one logical access point.

9. The method of claim 8, wherein receiving service component related parameters comprises receiving the service component related parameters via an external connection.

10. The method of claim 9, wherein selecting one of the plurality of service components comprises using the service component related parameters to reduce an initial number of potentially compatible service components.

11. The method of claim 10, wherein selecting one of the plurality of service components further comprises using the service component related parameters to initiate a business agreement with the one of the plurality of service components.

12. A system for facilitating network services in response to a service request and associated service request parameters, comprising:
a plurality of service components distributed within at least one network; and
an interface module having a plurality of interface objects to establish communications with one of the plurality of service components, the interface module including:
a lookup object in communication with the plurality of interface objects to establish connection parameters required between the one of the plurality of service components and one of the plurality of interface objects;
a data object in communication with the lookup object to provide parameters identifying attributes associated with the plurality of service components; and
a single logical access point to allow external access to the plurality of interface objects.

13. The system of claim 12, wherein the plurality of interface objects includes software objects accessible by messages received from the single logical access point.

14. The system of claim 13, wherein the lookup object comprises a matchmaking function to promote business agreements with the one of the plurality of service components in response to the associated service request parameters.

15. The system of claim 13, wherein the lookup object comprises a decision function to receive the associated service request parameters and to provide the required connection parameters in response to the associated service request parameters.

16. The system of claim 12, wherein the plurality of interface objects includes a plurality of network address translation proxies accessible by messages received from the single logical access point.

17. The system of claim 16, wherein the lookup object comprises a matchmaking function to promote business agreements with the one of the plurality of service components in response to the associated service request parameters.

18. The system of claim 16, wherein the lookup object comprises a decision function to receive the associated service request parameters and to provide the required connection parameters in response to the associated service request parameters.

19. A computer-readable medium having computer-executable instructions for establishing network services within a network having a plurality of service components, the computer-executable instructions performing steps comprising:
providing a plurality of interface modules to establish communications with one of the plurality of service components, wherein one logical access point to the plurality of interface modules allows external invocation of one of the plurality of service components;
optionally receiving service component related parameters; and
selecting one of the plurality of service components in response to the invocation, wherein the service component related parameters provides dynamic selection optimization of the one of the plurality of service components.

20. The computer-readable medium of claim 19, wherein the computer-executable instruction step of providing a plurality of interface modules comprises providing a plurality of software objects accessible by messages received from the one logical access point.

21. The computer-readable medium of claim 20, wherein the computer-executable instruction step of receiving service component related parameters comprises receiving the service component related parameters via the one logical access point.

22. The computer-readable medium of claim 21, wherein the computer-executable instruction step of receiving service component related parameters comprises receiving the service component related parameters via an external connection.

23. The computer-readable medium of claim 22, wherein the computer-executable instruction step of selecting one of the plurality of service components comprises using the service component related parameters to reduce an initial number of potentially compatible service components.

24. The computer-readable medium of claim 23, wherein the computer-executable instruction step of selecting one of the plurality of service components further comprises using the service component related parameters to initiate a business agreement with the one of the plurality of service components.

25. The computer-readable medium of claim 19, wherein the computer-executable instruction step of providing a plurality of interface modules comprises providing a plurality of network address translation proxies accessible by messages received from the one logical access point.

26. The computer-readable medium of claim 25, wherein the computer-executable instruction step of receiving service component related parameters comprises receiving the service component related parameters via the one logical access point.

27. The computer-readable medium of claim 26, wherein the computer-executable instruction step of receiving service component related parameters comprises receiving the service component related parameters via an external connection.

28. The computer-readable medium of claim 27, wherein the computer-executable instruction step of selecting one of the plurality of service components comprises using the service component related parameters to reduce an initial number of potentially compatible service components.

29. The computer-readable medium of claim 28, wherein the computer-executable instruction step of selecting one of the plurality of service components further comprises using the service component related parameters to initiate a business agreement with the one of the plurality of service components.
